(19) United States
(12) Patent Application Publication
(10) Pub. No.: US 2013/0152607 A1
(43) Pub. Date: Jun. 20, 2013

(54) PROCESS AND PLANT FOR THE VAPORIZATION OF LIQUEFIED NATURAL GAS AND STORAGE THEREOF

(71) Applicant: Liberato CICCARELLI, San Giuliano Milanese (IT)

(72) Inventor: Liberato CICCARELLI, San Giuliano Milanese (IT)

(21) Appl. No.: 13/675,803

(22) Filed: Nov. 13, 2012

Related U.S. Application Data
(63) Continuation of application No. 12/304,211, filed on Jan. 5, 2009, now abandoned.

(30) Foreign Application Priority Data
Jun. 14, 2006 (IT) MI2006A 001149

(51) Int. Cl. F17C 9/04

(52) U.S. Cl. CPC F17C 9/04
USPC 62/50.3

(57) ABSTRACT

A process and plant for the vaporization of liquefied natural gas includes obtaining electric energy during the vaporization operation by way of thermal exchange by transformation of an energy source for obtaining electric power.

### CROSS REFERENCE

This application is a continuation of and is based upon and claims the benefit of priority under 35 U.S.C. §120 for U.S. Ser. No. 12/304,211, filed Jan. 5, 2009, the entire contents of which are incorporated herein by reference. U.S. Ser. No. 12/304,211 is a National Stage of PCT/EP07/05032; filed Jun. 5, 2007, and claims the benefit of priority under 35 U.S.C. §119 from Italian Patent Application No. MI2006A 001149, filed Jun. 14, 2006.

### DESCRIPTION OF THE RELATED ART

As is known, in LNG terminals, gas in liquid state unloaded from methane-tankers is reconverted to the gaseous state. LNG is sent from the tanker to storage tanks on land, connected to re-gasification units normally through “primary pumps” with a low discharge head, immersed in the LNG inside the same tanks, followed by “secondary pumps”, for the compression of the liquid to the final pressure required by the users. The maintenance operations of the former are particularly complex and great efforts are being made to minimize its incidence, by producing pumps with a high reliability and adopting effective control systems. In order to reduce the costs of the system, a pump has recently been developed, having a high capacity and head, which could combine the functions of the two steps.

The core of the terminals consists of vaporizers: in practice these are heat exchangers in which LNG absorbs thermal energy and passes to the gaseous state. They are generally classified on the basis of the energy source, which can be the environment (water or air), an energy vector such as electric energy or a fuel, or a process fluid coming from various kinds of external plants.

There are mainly two types of vaporizers used in terminals currently operating, the “seawater” type (or Open Rack Vaporizers, ORV) and the “immersed flame” type (called SMV or SCV), which can be classified, respectively, in the first and second of the three categories mentioned above.

A series of auxiliary systems are present in the terminals, which provide the services necessary for the functioning of the plant under safety and economical conditions.

The current vaporizers, however, have several drawbacks, as mentioned hereunder.

In the first place, there is the necessity of producing new vaporizer terminals in Countries which have a rapid increase in natural gas consumption, against a less rapid debottlenecking of importation gas pipelines.

Secondly, the present systems do not allow energy efficiency to be pursued together with the exploitation of the energy contained in Liquefied Natural Gas, which is known in Anglo-Saxon countries as LNG Cold Utilization and Cryogenic Power Generation. In addition to this, there is the fact that storage in a lung-tank implies significantly high construction, maintenance and management costs.

Yet another fact is that present vaporizer terminals have numerous problems relating to Environmental Impact and acceptance on the part of the Communities, which, in the past, were among the main obstacles, together with the problem of safety, for the production of new vaporizers.

### SUMMARY OF THE INVENTION

The aim of the present invention is to eliminate the above drawbacks of the known art.

Within this commitment, an important objective of the invention is to provide a process and plant for the vaporization of liquefied natural gas (LNG) and its storage, which allow the vaporization of LNG coming from procurement countries situated far from inhabited centres.

A further objective of the invention is to provide a process and plant for the vaporization of liquefied natural gas (LNG) and its storage, which allow electric power to be produced with high q values, contextually with the vaporization.

Yet another objective of the invention relates to a process and plant for the vaporization of liquefied natural gas (LNG) and its storage, which allow the regasified natural gas to be injected in an exhausted off-shore reservoir.

An additional objective of the invention is to provide a process and plant for the vaporization of liquefied natural gas (LNG) and its storage, which allow the natural gas injected to be used by sending it to the supply system by means of existing infrastructures.

These solutions prove to be particularly interesting for various reasons. In the first place, the necessity of studying vaporization terminals is becoming increasing more crucial in countries in which the quantity of natural gas consumption is rapidly increasing against a less rapid debottlenecking of importation gas pipelines.

Secondly, the pursuit of energy efficiency goes together with the exploitation of the energy contained in Liquefied Natural Gas, which is known in Anglo-Saxon countries as LNG Cold Utilization and Cryogenic Power Generation. With this, there is the additional fact that storage in a lung-tank could be effected in the form of natural gas in one of the many already or almost exhausted reservoirs. Finally, a last advantage, which could prove to be decisive, lies in the fact that the effecting of reinjection offshore avoids numerous problems relating to Environmental Impact Assessment and acceptance on the part of Communities, which in the past were among the main obstacles for the production of vaporizers.

This assignment together with these and other objectives are achieved in a process and plant for the vaporization of liquefied natural gas (LNG) characterized in that electric power is obtained during said vaporization operation by means of thermal exchange.

An object of the present patent invention also relates to a liquefied natural gas (LNG) vaporization plant characterized in that it comprises transformation means of an energy source for obtaining electric power during said vaporization operation by means of thermal exchange.

The process preferably comprises the following steps:
pumping the LNG at a substantially constant temperature;
vaporizing, at a substantially constant pressure, the LNG pumped by means of thermal exchange with a permanent heat-releasing gas in a closed cycle;
sending most of the regasified LNG for storage in a reservoir;
burning and expanding the remaining part of vaporized LNG not sent for storage in a gas turbine obtaining discharge gases;
subjecting the permanent gas, after compression heat-releasing, to subsequent thermal exchange in a closed cycle with the heat-releasing discharge gases and finally to expansion in a turbine,
   the electric power being produced both by the turbine in which the remaining regasified part of LNG not sent for storage is burnt and expanded and by the turbine in which the heated compressed permanent gas is expanded.

The reservoir in which most of the regasified LNG is injected must be exhausted or at least partially exhausted.

The pumping of the LNG is effected at a substantially constant temperature preferably ranging from −155 to −165° C., more preferably from −160 to −163° C., bringing the pressure of said LNG from about 1 bar to a value preferably ranging from 120 to 180 bars, more preferably from 120 to 150 bars.

The vaporization of the LNG pumped takes place at a substantially constant pressure preferably ranging from 120 to 180 bars, more preferably from 120 to 150 bars, bringing the temperature to a value preferably ranging from 10 to 25° C.

The remaining part of vaporized LNG not sent for reservoir storage preferably ranges from 3 to 8% of the whole stream of vaporized LNG.

Said remaining part of non-stored vaporized LNG is burnt and expanded in a turbine up to a pressure preferably of 1 bar. The permanent gas is preferably selected from helium and nitrogen.

When the permanent gas selected is nitrogen, the thermal exchange with the compressed LNG can take place at a substantially constant pressure preferably ranging from 2 to 5 bars bringing the temperature from a value preferably ranging from 75 to 100° C. to a value preferably ranging from −150 to −130° C. and the thermal exchange with the discharge gases can take place at a substantially constant pressure preferably ranging from 50 to 60 bars bringing the temperature from a value preferably ranging from 20 to 40° C. to a value preferably ranging from 400 to 450° C.

The CO₂ contained in the discharge gases leaving the thermal exchange can be optionally sequestered: one of the possible ways consists in injecting it into a reservoir, possibly the same reservoir at a different level.

An alternative to the vaporization of LNG directly removed from methane-tankers can be temporary storage in suitable tanks, in order to reduce the residence times in the methane-tanker terminals.

The current generators coupled with the turbines, availing of cooling LNG, can also be produced with the superconductor technology and can therefore generate large capacities with small weights.

The turbines used as means for the reintroduction of vaporized gas, can be advantageously managed and supported by means of a supplementary marine platform.

The process according to the invention allows a considerable flexibility as it uses gas turbine or gas expansion cycles without vapour cycles which, on the contrary, are extremely rigid.

The process can in fact function with supplied power or vaporized LNG flow-rates ranging from 0 to 100% as the permanent gas closed cycle can be effected with varying flow-rates.

Further characteristics and advantages of the invention will appear more evident from the description of a preferred but non-limiting embodiment of a process and plant for the vaporization of liquefied natural gas (LNG) and its storage, according to the invention, illustrated for indicative and non-limiting purposes in the enclosed drawings, in which:

### BRIEF DESCRIPTION OF THE DRAWINGS

FIG. 1 shows a flow chart of the gasification plant.

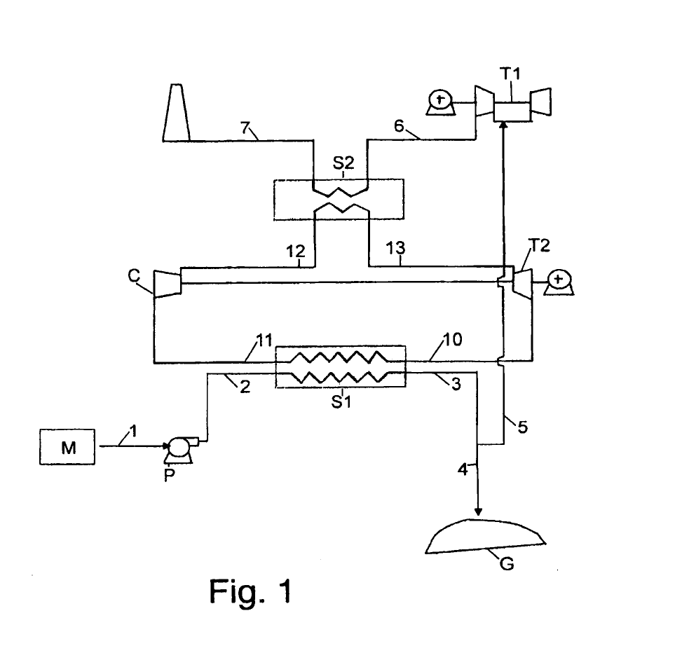

FIG. 2 shows a block scheme of the various process phases according to the invention.

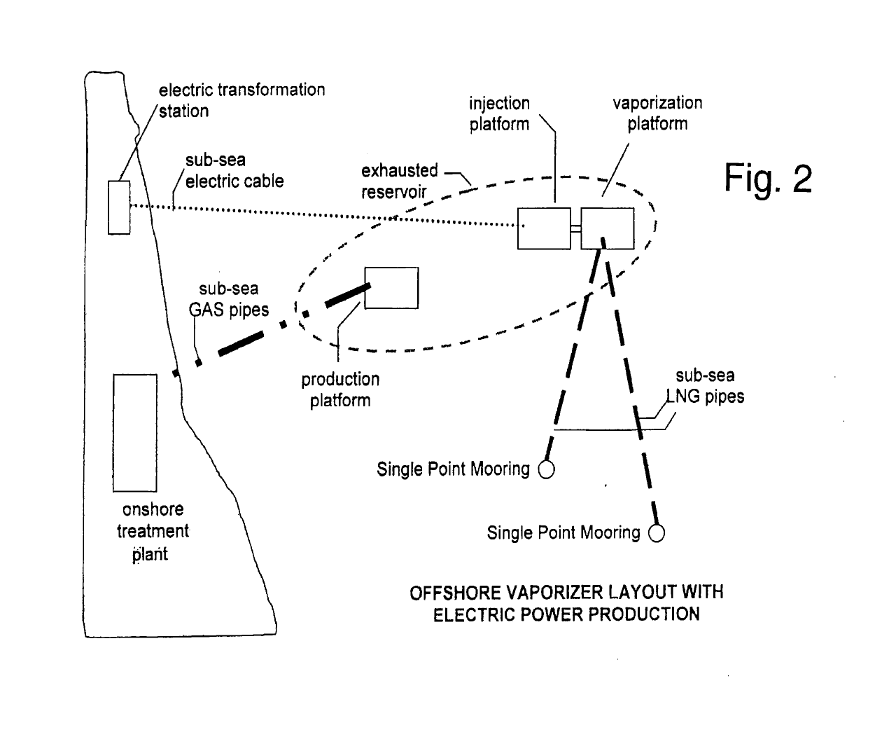

### DETAILED DESCRIPTION OF THE PREFERRED EMBODIMENTS

The liquefied LNG (1) is first pumped from a methane-tanker (M) (T=−162° C.; P=1 bar) by means of a pumping unit (P) at a pressure of 130 bars, maintaining the temperature substantially constant, and the LNG pumped (2) is then vaporized in the exchanger (S) by means of heat exchange with a permanent gas in a closed cycle by heating to a temperature of 15° C. and keeping the pressure substantially constant, except for pressure drops.

Most (4) of the vaporized LNG (3) (95% by volume) is sent for storage in a reservoir (G), whereas the remaining part (5) (5%) is burnt and expanded in a gas turbine (T1).

The discharge gases (6) leaving the turbine (T1) at a pressure of 1 bar and a temperature of 464° C. are subjected to thermal exchange in the exchanger (S2) by means of thermal exchange with the permanent gas in a closed cycle to which they transfer heat.

The CO₂ contained in the discharge gases (7) leaving the exchanger (S2) can be optionally sequestered. The closed cycle of the permanent gas comprises the thermal exchange of the gas (10) with the LNG compressed with the exchanger (S1) effected at a substantially constant pressure, a compression of the cooled gas (11) leaving the exchanger (S1) by means of the compressor (C) with a temperature increase, thermal exchange with the discharge gases by means of the exchanger (S2) at a substantially constant pressure and finally an expansion of the heated gas (13) leaving the exchanger (S2) by means of the turbine (T2) with a reduction in the temperature.

The LNG passes from the discharge points of the ship onto to the vaporization platform where it undergoes the process described in the subsequent point 2. The vaporized product, at a pressure of 130 bars, is reinjected into the reservoir. If requested by the distribution network, it is produced and sent to land by means of underwater pipelines to the on-shore treatment plant. If the demand absorbs the whole vaporization product, the gas can be sent directly to the distribution network skipping dehydration in the on-shore plant.

The process and plant for the vaporization of liquefied natural gas (LNG) and its storage thus conceived can undergo numerous modifications and variations, all included in the scope of the inventive concept; furthermore, all the details can be substituted with technically equivalent elements.

1. A process for the vaporization of liquefied natural gas (LNG) and its storage, the process comprising:
production of electric power during said vaporization operation by means of thermal exchange,
wherein said thermal exchange is carried out by means of a heating-releasing permanent gas in a closed cycle in which at least a first part of said vaporized LNG is injected for storage into a pre-existing natural gas reservoir,
wherein said natural gas reservoir is at least partially exhausted, and
wherein a remaining part of non-stored vaporized LNG is burnt and expanded in a turbine.

2. The process according to any one of the previous claims, wherein said permanent gas takes heat from the discharge gases of at least a first gas turbine which burns a second part of the vaporized LNG not sent for storage.

3. The process according to any one of the previous claims, wherein LNG is vaporized at a substantially constant pressure and pumped by means of thermal exchange with said heat-releasing permanent gas in a closed cycle.

4. The process according to any one of the previous claims, wherein in said closed cycle said permanent gas, after the releasing of heat, is subjected to a subsequent thermal exchange with said heat-releasing discharge gases of said turbine and finally to expansion in at least a second turbine.

5. The process according to any one of the previous claims, wherein said electric power is produced by both said first turbine in which the remaining vaporized part of LNG not sent for storage is burnt and expanded and also by said second turbine in which said heated compressed permanent gas is expanded.

6. The process according to any one of the previous claims, wherein said pumping of LNG is effected at a substantially constant temperature ranging from −155 to −165° C. bringing the pressure of said LNG from about 1 bar to a value ranging from 120 to 180 bars.

7. The process according to any one of the previous claims, wherein said substantially constant temperature ranges from −160 to −163° C. and the pressure is brought to a value ranging from 120 to 150 bars.

8. The process according to any one of the previous claims, wherein said vaporization of LNG takes place at a substantially constant pressure ranging from 120 to 180 bars bringing the temperature to a value ranging from 10 to 25° C.

9. The process according to any one of the previous claims, wherein said first part of vaporized LNG not sent for storage in a reservoir ranges from 3 to 8% of the whole vaporized LNG stream.

10. The process according to any one of the previous claims, wherein said second part of non-stored vaporized LNG is burnt and expanded in a turbine up to a pressure of about 1 bar.

11. The process according to any one of the previous claims, wherein said permanent gas is preferably selected from helium and nitrogen.

12. The process according to any one of the previous claims, wherein when said permanent gas is nitrogen, the thermal exchange with compressed LNG takes place at a substantially constant pressure ranging from 2 to 5 bars bringing the temperature from a value ranging from 75 to 100° C. to a value ranging from −150 to −130° C. and the thermal exchange with the discharge gases takes place at a substantially constant pressure ranging from 50 to 60 bars bringing the temperature from a value ranging from 20 to 40° C. to a value ranging from 400 to 450° C.

13. The process according to any one of the previous claims, wherein said electric power obtained from said first and second turbine is produced in current generators coupled with the turbines themselves effected with the super

14. The process according to any one of the previous claims, wherein said LNG is transported by means of methane-tankers and before being subjected to said pumping and subsequent vaporization, it is subjected to temporary storage in suitable tanks.

15. The process according to any one of the previous claims, wherein the CO₂ contained in said discharge gases is sequestered.

16. The process according to any one of the previous claims, wherein said sequestered CO₂ is injected into said reservoir.

17. A plant for the vaporization of liquefied natural gas (LNG), comprising:
transformation means of an energy source for obtaining electric power during said vaporization operation by means of thermal exchange,
wherein said transformation means includes at least a first turbine in which a remaining vaporized part of LNG not sent for storage is burnt and expanded and at least a second turbine in which a heated compressed permanent gas is expanded.

18. The plant according to claim 17, wherein said electric power obtained from said first and second turbine is produced in current generators coupled with the turbines themselves effected with the superconductor technology.

19. The plant according to claim 18, further comprising a supplementary marine platform for supporting at least said turbines and reintroduction means of said vaporized gas into an at least partially exhausted natural reservoir.
